(19) United States
(12) Patent Application Publication
(10) Pub. No.: US 2020/0183449 A1
(43) Pub. Date: Jun. 11, 2020

(54) FILM LAYER STRUCTURE FOR DISPLAY DEVICE

(71) Applicant: Wuhan China Star Optoelectronics Semiconductor Display Technology Co., Ltd., Wuhan (CN)

(72) Inventor: Min CHEN, Wuhan (CN)

(73) Assignee: Wuhan China Star Optoelectronics Semiconductor Display TechnologyCo., Ltd., Wuhan (CN)

(21) Appl. No.: 16/467,052

(22) PCT Filed: Apr. 17, 2019
(86) PCT No.: PCT/CN2019/083002

§ 371 Date: Jun. 6, 2019

(30) Foreign Application Priority Data
Dec. 4, 2018 (CN) 201811474954.0

(51) Int. Cl. G06F 1/16; G02B 1/08; G02B 1/14

(52) U.S. Cl. CPC G06F 1/1609; G02B 1/14; G02B 1/08

(57) ABSTRACT

A film layer structure for a display device is provided. The film layer structure includes a protective area, to form the film layer structure required for the display device; an edge-corner material area, to protect the protective area when the film layer is formed; and a cutting area, between the protective area and the edge-corner material area, for cutting to form the protective area; wherein the cutting area includes a target area, and a first thickness of the target area is less than a second thickness of the protective area.

### FIELD OF INVENTION

The present invention relates to the field of display, and in particular to a film layer structure for a display device.

### BACKGROUND OF INVENTION

In order to realize a narrow frame of the display device, the most critical one is laser anisotropic cutting technology, the principle of which is to ablate product film material by high energy laser to cause vaporization reaction. However, when the material is vaporized, it will produce a pungent odor on the one hand and a large amount of ash on the other hand, which will reduce cutting quality.

The structure of the film layer of an OLED product in the prior art is shown in FIG. 1, and a schematic diagram of the narrow frame design using laser cutting to cut off a dummy area of edge is shown in FIG. 2. However, the laser cutting process produces a pungent odor and a large amount of ash, which reduces the cutting quality and product yield.

Therefore, how to reduce the ash and pungent odor and improve the cutting quality and product yield is a technical problem to be solved by those skilled in the art.

### SUMMARY OF INVENTION

### Technical Problem

The present invention provides a film layer structure for a display device for alleviating the technical problem of pungent odor, a large amount of ash, and reduction of cutting quality and product yield in the prior laser cutting process.

### Technical Solution

The invention provides a film layer structure for a display device, comprising:

a protective area, for forming the film layer structure required for the display device;

an edge-corner material area, for protecting the protective area when the film layer is formed; and

a cutting area, between the protective area and the edge-corner material area, for cutting to form the protective area;

wherein the cutting area includes a target area; a first thickness of the target area is less than a second thickness of the protective area;

the cutting area is provided with at least two of the target areas; and

the target area is circular in shape.

In the film layer structure for a display device provided by the present invention, the film layer structure includes a back panel, the back panel includes three back panel sub-film layers of a back panel body, a protective film and a release film, and the back panel has at least one of the back panel sub-film layers provided with the target area.

In the film layer structure for a display device provided by the present invention, the film layer structure includes a back panel, the back panel includes at most two of the back panel sub-film layers in a back panel body, a protective film and a release film, and the back panel has at least one of the back panel sub-film layers provided with the target area.

In the film layer structure for a display device provided by the present invention, the back panel includes the back panel body and the release film, and the back panel body is provided with the target area.

In the film layer structure for a display device provided by the present invention, the film layer structure includes a polarizer, the polarizer includes four polarizing sub-film layers of a polarizing layer, a pressure sensitive adhesive, a release film and a protective film, and the polarizer has at least one of the polarizing sub-film layers provided with the target area.

In the film layer structure for a display device provided by the present invention, the film layer structure includes a polarizer, the polarizer includes at most three of polarizing sub-film layers in a polarizing layer, a pressure sensitive adhesive, a release film and a protective film, and the polarizer has at least one of the polarizing sub-film layers provided with the target area.

In the film layer structure for a display device provided by the present invention, the polarizer includes the polarizing layer, the pressure sensitive adhesive and the release film, and the polarizing layer and the release film are provided with the target area.

The invention also provides a film layer structure for a display device, comprising:

a protective area, for forming the film layer structure required for the display device;

an edge-corner material area, for protecting the protective area when the film layer is formed; and

a cutting area, between the protective area and the edge-corner material area, for cutting to form the protective area;

wherein the cutting area includes a target area, and a first thickness of the target area is less than a second thickness of the protective area.

In the film layer structure for a display device provided by the present invention, the thickness of the target area is greater than zero, and the target area is the cutting area.

In the film layer structure for a display device provided by the present invention, the cutting area is provided with at least two of the target areas.

In the film layer structure for a display device provided by the present invention, the target area has a thickness of zero.

In the film layer structure for a display device provided by the present invention, the film layer structure includes a back panel, the back panel includes three back panel sub-film layers of a back panel body, a protective film and a release film, and the back panel has at least one of the back panel sub-film layers provided with the target area.

In the film layer structure for a display device provided by the present invention, the film layer structure includes a back panel, the back panel includes at most two of the back panel sub-film layers in a back panel body, a protective film and a release film, and the back panel has at least one of the back panel sub-film layers provided with the target area.

In the film layer structure for a display device provided by the present invention, the back panel includes the back panel body and the release film, and the back panel body is provided with the target area.

In the film layer structure for a display device provided by the present invention, the film layer structure includes a polarizer, the polarizer includes four polarizing sub-film layers of a polarizing layer, a pressure sensitive adhesive, a release film and a protective film, and the polarizer has at least one of the polarizing sub-film layers provided with the target area.

In the film layer structure for a display device provided by the present invention, the film layer structure includes a polarizer, the polarizer includes at most three of polarizing sub-film layers in a polarizing layer, a pressure sensitive adhesive, a release film and a protective film, and the polarizer has at least one of the polarizing sub-film layers provided with the target area.

In the film layer structure for a display device provided by the present invention, the polarizer includes the polarizing layer, the pressure sensitive adhesive and the release film, and the polarizing layer and the release film are provided with the target area.

In the film layer structure for a display device provided by the present invention, the film layer structure includes a thin film transistor, the thin film transistor includes a metal layer, and the metal layer is provided with the target area.

In the film layer structure for a display device provided by the present invention, the target area is circular in shape.

In the film layer structure for a display device provided by the present invention, a width of the cutting area is greater than 30 μm.

### Beneficial Effects

Embodiments of the present invention provide a film layer structure for a display device, the film layer structure including a protective area, to form the film layer structure required for the display device; an edge-corner material area, to protect the protective area when the film layer is formed; and a cutting area, between the protective area and the edge-corner material area, for cutting to form the protective area; wherein the cutting area includes a target area, and the first thickness of the target area is less than the second thickness of the protective area; and when the thickness of the protective area of the film layer structure is constant, by reducing the thickness of the cutting area in the film layer structure, the material vaporized in the cutting area is reduced during the laser cutting process, thereby reducing the ash and pungent odor after laser anisotropic cutting, and improving the cutting quality and product yield.

### DESCRIPTION OF DRAWINGS

In order to more clearly illustrate the technical solutions in the embodiments of the present invention, the drawings used in the description of the embodiments will be briefly described below. It is obvious that the drawings in the following description are only some embodiments of the present invention. Other drawings can also be obtained from those skilled in the art based on these drawings without paying any creative effort.

FIG. 1 is a schematic view of a film layer structure of an OLED product in the prior art;

FIG. 2 is a schematic view of laser cutting of an OLED product in the prior art;

FIG. 3 is a schematic view of a first film layer structure of a back panel of the present invention;

FIG. 4 is a schematic view of a second film layer structure of a back panel of the present invention;

FIG. 5 is a schematic view of a third film layer structure of a back panel of the present invention;

FIG. 6 is a schematic view of a fourth film layer structure of a polarizer of the present invention;

FIG. 7 is a schematic view of a fifth film layer structure of a polarizer of the present invention;

FIG. 8 is a schematic view of a sixth film layer structure of a polarizer of the present invention; and

FIG. 9 is a schematic view of a film layer structure of a metal layer of a thin film transistor of the present invention.

### DETAILED DESCRIPTION OF PREFERRED EMBODIMENTS

The following description of the embodiments is with reference to the drawings and is provided to illustrate the specific embodiments of the invention. The directional terms mentioned in the present invention, such as ‘upper’, ‘lower’, ‘front’, ‘back’, ‘left’, ‘right’, ‘top’, ‘bottom’, etc., are only the directions in the drawings. Therefore, the directional terminology used is for the purpose of illustration and understanding of the invention rather than limiting the invention. In the figures, structurally similar elements are denoted by the same reference numerals.

The present invention is directed to the problem of the existing display device which generates more ash and pungent odor during the cutting process and reduces cutting quality and product yield. Embodiments of the present invention can alleviate this problem.

As shown in FIG. 1, the existing OLED film layer structure includes a polarizer 11, a touch screen 12, an encapsulation layer 13, an OLED 14, a flexible substrate 15, and a back panel 16. Thickness of each film layer structure is as shown in Table 1 below:

TABLE 1

| Film Layer Structure | Thickness/um |
|---|---|
| BP | 100 |
| Flexible Substrate | 20 |
| OLED | 0.3 |
| TFE | 5 |
| TP | 80 |
| POL | 100 |

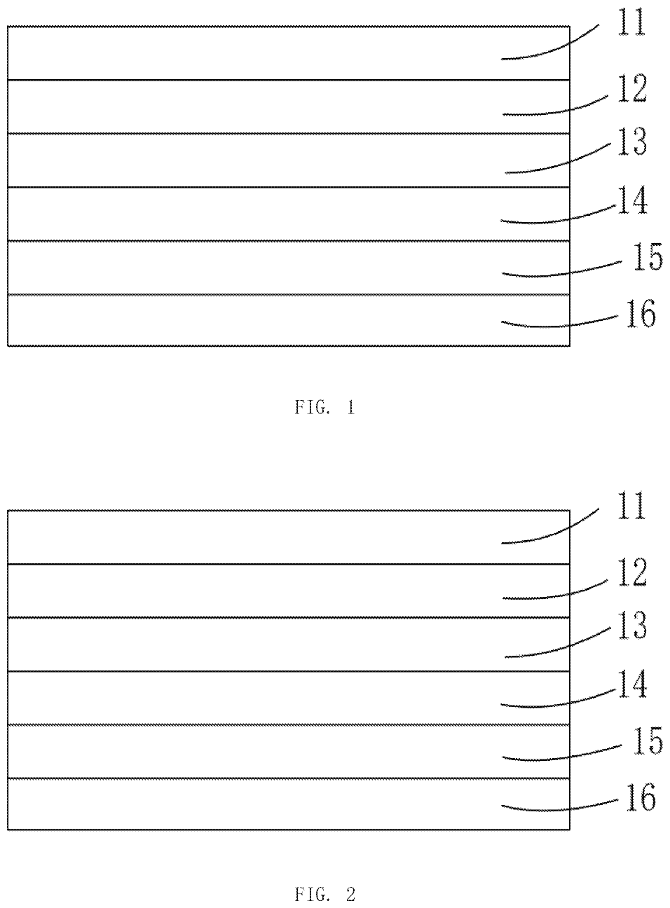

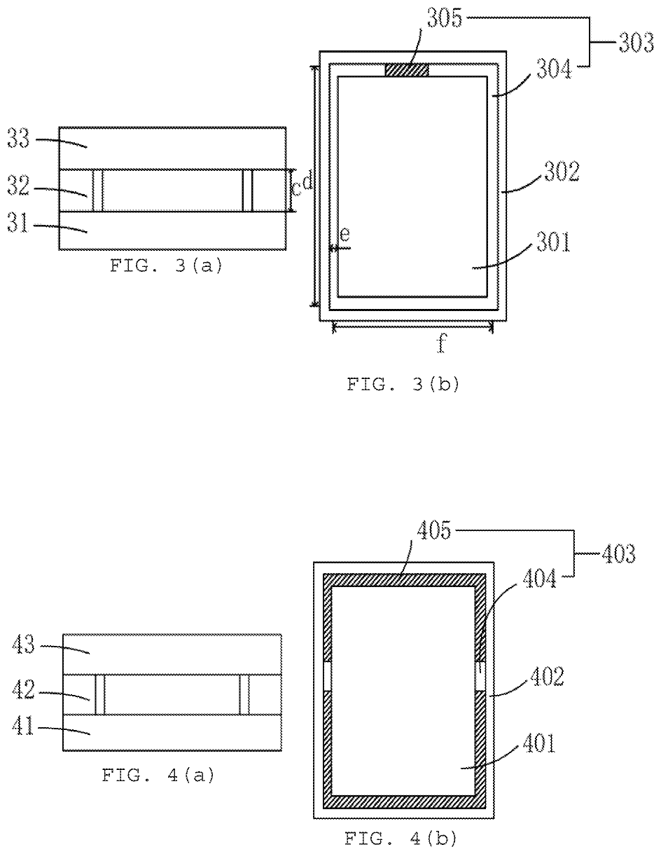

It can be seen from Table 1 that the thickness of the back panel and the polarizer is the largest, accounting for about ⅔ of the thickness of the entire product film. In the laser anisotropic cutting process, as shown in FIG. 2, when the polarizer 21, the touch screen 22, the encapsulation layer 23, the OLED 24, the flexible substrate 15 and the back panel 26 in the OLED film layer structure are cut through a cutting track 27 to remove the dummy area 28, there will be a lot of ash and pungent smell, so it is necessary to reduce the ash and pungent smell to improve cutting quality and product yield. In combination with analysis of Table 1, the embodiments of the present invention improve the film layer structures of the back panel and polarizer.

As shown in FIG. 3, the embodiment of the present invention provides a film layer structure of the back panel, as shown in FIG. 3(a), including a protective film 31, a back panel body 32 and a release film 33, to improve the structure of the back panel body 32. As shown in FIG. 3(b), the back panel body is provided with a protective area 301 and an edge-corner material area 302. A cutting area 303 of the back panel is disposed between the protective area 301 of the back panel and the edge-corner material area 302 of the back panel. The cutting area 303 of the back panel is provided with a target area 304 and a first connection area 305. The target area 304 of the back panel has a thickness of 0, that is, the target area 304 of the back panel is empty. The first connection area is connected to the protective area 301 of the back panel and the edge-corner material area 302 of the back panel. The thickness of the first connection area 305 is the same as the thickness of the protective area 30 of the back panel. As shown in FIG. 3, assuming that the width of the protective area of the back panel is f, with the length of d, and the thickness of the cutting area of the back panel is c, with the width of the cutting track being e, the volume of the amount of ash that can be reduced when cutting the back panel is V=2(d+f)*c*e Due to the reduction of the amount of ash, the pungent odor during vaporization will be reduced, so the cutting quality and product yield are improved.

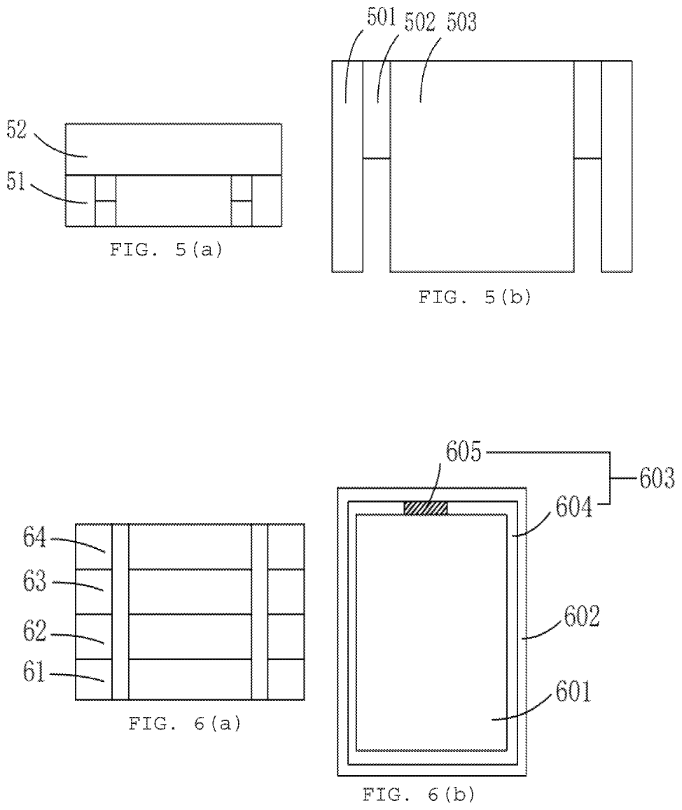

As shown in FIG. 4, the embodiment of the present invention provides a film layer structure of the back panel, as shown in FIG. 4(a), including a protective film 41, a back panel body 42 and a release film 43, to improve the structure of the back panel body 42. As shown in FIG. 4(b), the back panel body 42 includes a protective area 401 and an edge-corner material area 402. A cutting area 403 of the back panel is disposed between the protective area 401 of the back panel and the edge-corner material area 402. The cutting area 403 of the back panel is provided with two target areas 404 and a second connection area 405. The target areas 404 have a thickness of 0, that is, the target areas 404 are empty. The second connection area 405 is connected to the protective area 401 of the back panel and the edge-corner material area 402 of the back panel. By providing two target areas and changing the thickness of the target areas to zero, the material of the cutting area is reduced, thereby reducing the amount of ash during the cutting process while reducing the pungent odor, so the cutting quality and product yield are improved.

In the embodiment of the present invention, when the thickness of the back panel is larger, the thickness of the protective area is constant. While each layer of the back panel is retained, by reducing the material of the cutting area of the back panel, the ash generated during the laser anisotropic cutting and the odd during vaporization are reduced, thereby improving the cutting quality and product yield. The present invention divides the cutting area of the back panel into the target area and the connection area. By providing one or more target areas, the thickness of the target areas can be reduced to different levels. Besides, the structure can be applied to any layer of the back panel body, the protective film and the release film, can be applied to any two layers of the back panel body, the protective film and the release film, and can be simultaneously applied to three layers of the back panel body, the protective film and the release film. Therefore, the material of the cutting area is reduced to different levels, and the amount of ash and pungent odor are reduced, thereby raising the effect of the cutting quality and product yield.

As shown in FIG. 5, the embodiment of the present invention provides a film layer structure of the back panel, as shown in FIG. 5(a), including a back panel body 51 and a release film 52, to improve the film layer structure of the back panel body 51. The back panel body 51 includes an edge-corner material area 501 and a protective area 503. A cutting area 502 is disposed between the edge-corner material area 501 of the back panel body and the protective area 503 of the back panel body; wherein the target area is the cutting area 502, and the thickness of the cutting area 502 of the back panel body is lower than the thickness of the protective area 503 of the back panel body. By disposing the target area and reducing the overall thickness of the target area, the amount of ash and pungent odor produced is reduced, and the cutting quality and product yield are improved.

The embodiment of the present invention changes the film layer structure to make the back panel into a back panel body and a release film composition. And then, by improving the cutting area, disposing the target area in the cutting area, and reducing the overall thickness of the target area, the film layer structure can be applied to any layer of the back panel body and the release film, and can be applied to both the back panel body and the release film at the same time, thereby reducing the thickness of the target area and reducing the amount of ash and pungent odor generated by the laser cutting, It improves the cutting quality and product yield.

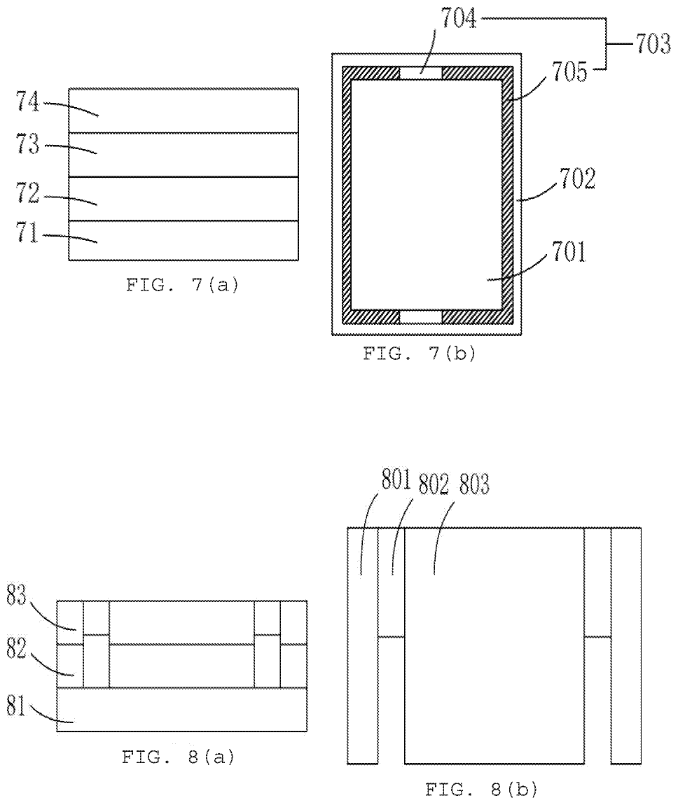

As shown in FIG. 6, the embodiment of the present invention provides a film layer structure of a polarizer. As shown in FIG. 6(a), the polarizer includes a release film 61, a pressure sensitive adhesive 62, a polarizer 63, and a protective film 64, and performs the same improvement on the respective film layers. As shown in FIG. 6(b), the polarizer is provided with a protective area 601 and an edge-corner material area 602. A cutting area 603 of the polarizer is disposed between the protective area 601 of the polarizer and the edge-corner material area 602 of the polarizer. The cutting area 603 of the polarizer is provided with a target area 604 and a third connection area 605. The third connection area 605 is connected to the protective area 601 of the polarizer and the edge-corner material area 602 of the polarizer. By disposing the target area 604 in the cutting area 603 of the polarizer and changing the thickness of the target area 604 of the polarizer to 0, that is, the target area 604 of the polarizer is empty, the material of the cutting area is reduced and the amount of ash and pungent odor generated by laser cutting is reduced, thereby improving the cutting quality and product yield.

As shown in FIG. 7, the embodiment of the present invention provides a film layer structure of a polarizer. As shown in FIG. 7(a), the polarizer includes a release film 71, a pressure sensitive adhesive 72, a polarizing layer 73, and a protective film 74, and the polarizing layer 73 is improved. As shown in FIG. 7(b), the polarizing layer 73 includes a protective area 701 and an edge-corner material area 702. A cutting area 703 of the polarizer is disposed between the protective area 701 of the polarizer and the edge-corner material area 702 of the polarizer. The cutting area 703 of the polarizer is provided with two target areas 704 and a fourth connection area 705. The fourth connection area 705 is connected to the protective area 701 of the polarizer and the edge-corner material area 702 of the polarizer. By disposing the target area 704 in the cutting area 703, the material of the cutting area is reduced and so the amount of ash and pungent odor generated by laser cutting is reduced, thereby improving the cutting quality and product yield.

The embodiment of the present invention finds after analysis that the thickness of the polarizer in the product is larger, and when the thickness of the protective area is constant, while retaining each layer, a target area or a plurality of target areas are disposed in the cutting area. Also, the target area can be disposed on any layer of the release film, the pressure sensitive adhesive, the polarizing layer, and the protective film, can be disposed on any two of the layers, can be disposed on any three layers, and can be disposed on four layers at the same time, thereby reducing the material of the cutting area. It reduces the amount of ash and pungent odor generated during laser cutting, improving the cutting quality and product yield.

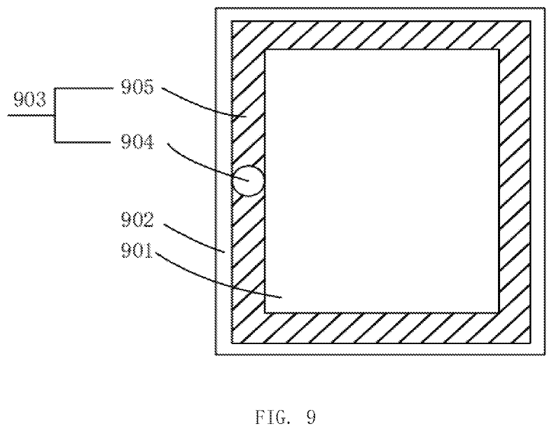

As shown in FIG. 8, the embodiment of the present invention provides a film layer structure of a polarizer, as shown in FIG. 8(a), including a release film 81, a pressure sensitive adhesive 82 and a polarizing layer 83, to improve the pressure sensitive adhesive 82 and the polarizing layer 83. As shown in FIG. 8(b), an edge-corner material area 801 and a protective area 803 are included. A cutting area 802 of the polarizer is disposed between the edge-corner material area 801 of the polarizer and the protective area 803 of the polarizer. The target area is the cutting area 802 of the polarizer, and the thickness of the cutting area 802 of the polarizer is lower than the thickness of the protective area 803 of the polarizer. By reducing the overall thickness of the cutting area, the amount of ash and pungent odor generated by laser cutting is reduced, and the cutting quality and product yield are improved.

The embodiment of the present invention reduces the thickness of the target area by changing the structure of the polarizer while disposing the target area in the cutting area. Also, the film layer structure of the polarizer can be disposed on any layer of the polarizing layer, the release film, and the pressure sensitive adhesive. It can be disposed on any two layers at the same time, and it can be disposed on three layers at the same time, which reduce the amount of ash and pungent odor generated during laser cutting and improve the cutting quality and product yield.

In the embodiment of the present invention, it is found after analysis that the back panel and the polarizer have a larger thickness in the product, and the back panel and the polarizer have a multi-layer structure, so that each layer of the back panel and the polarizer can be improved. The target area is disposed in the cutting area, the thickness of the target area is reduced, and the target area can be multiple, thereby reducing the material of the cutting area to different extents, and achieving both the goal of reducing the amount of ash and pungent odor generated during laser cutting and the goal of improving the cutting quality and product yield.

As shown in FIG. 9, the embodiment of the present invention provides a film layer structure of a metal layer of a thin film transistor, the metal layer is provided with a protective area 901 and an edge-corner material area 902. A cutting area 903 of the metal layer is disposed between the protective area 901 of the metal layer and the edge-corner material area 902 of the metal layer. The cutting area 903 of the metal layer is provided with a target area 904 and a fifth connection area 905. The target area 904 is circular and has a thickness of 0, that is, the target area 904 is empty. The ash and pungent odor generated by laser cutting are reduced, and the cutting quality and product yield are improved.

In the film layer structure provided by the embodiment of the present invention, the film layer structure is improved. A target area is disposed on the cutting area; the size, shape and thickness of the target area can be adjusted; and the material of the cutting area is reduced to different extents. It reduces the amount of ash and pungent odor of laser cutting, improving the cutting quality and product yield.

According to the above embodiments, it can be known that:

Embodiments of the present invention provide a film layer structure for a display device, the film layer structure including a protective area, to form the film layer structure required for the display device; an edge-corner material area, to protect the protective area when the film layer is formed; and a cutting area, between the protective area and the edge-corner material area, for cutting to form the protective area; wherein the cutting area includes a target area, and the first thickness of the target area is less than the second thickness of the protective area; and when the thickness of the protective area of the film layer structure is constant, by reducing the thickness of the cutting area in the film layer structure, the material vaporized in the cutting area is reduced during the laser cutting process, thereby reducing the ash and pungent odor after laser anisotropic cutting, and improving the cutting quality and product yield.

In the above, although the present invention has been disclosed in the above preferred embodiments, the above-described preferred embodiments are not intended to limit the invention, and those skilled in the art can make various changes and retouches without departing from the spirit and scope of the present invention. The scope of protection of the present invention is determined by the scope defined by the claims.

What is claimed is:

1. A film layer structure for a display device, comprising:
a protective area, for forming the film layer structure required for the display device;
an edge-corner material area, for protecting the protective area when the film layer is formed; and
a cutting area, between the protective area and the edge-corner material area, for cutting to form the protective area;
wherein the cutting area includes a target area; a first thickness of the target area is less than a second thickness of the protective area;
the cutting area is provided with at least two of the target areas; and
the target area is circular in shape.

2. The film layer structure as claimed in claim 1, wherein the film layer structure includes a back panel, the back panel includes three back panel sub-film layers of a back panel body, a protective film and a release film, and the back panel has at least one of the back panel sub-film layers provided with the target area.

3. The film layer structure as claimed in claim 1, wherein the film layer structure includes a back panel, the back panel includes at most two of the back panel sub-film layers in a back panel body, a protective film and a release film, and the back panel has at least one of the back panel sub-film layers provided with the target area.

4. The film layer structure as claimed in claim 3, wherein the back panel includes the back panel body and the release film, and the back panel body is provided with the target area.

5. The film layer structure as claimed in claim 1, wherein the film layer structure includes a polarizer, the polarizer includes four polarizing sub-film layers of a polarizing layer, a pressure sensitive adhesive, a release film and a protective film, and the polarizer has at least one of the polarizing sub-film layers provided with the target area.

6. The film layer structure as claimed in claim 1, wherein the film layer structure includes a polarizer, the polarizer includes at most three of polarizing sub-film layers in a polarizing layer, a pressure sensitive adhesive, a release film and a protective film, and the polarizer has at least one of the polarizing sub-film layers provided with the target area.

7. The film layer structure as claimed in claim 5, wherein the polarizer includes the polarizing layer, the pressure sensitive adhesive and the release film, and the polarizing layer and the release film are provided with the target area.

8. A film layer structure for a display device, comprising:
a protective area, for forming the film layer structure required for the display device;
an edge-corner material area, for protecting the protective area when the film layer is formed; and
a cutting area, between the protective area and the edge-corner material area, for cutting to form the protective area;
wherein the cutting area includes a target area, and a first thickness of the target area is less than a second thickness of the protective area.

9. The film layer structure as claimed in claim 8, wherein the thickness of the target area is greater than zero, and the target area is the cutting area.

10. The film layer structure as claimed in claim 8, wherein the cutting area is provided with at least two of the target areas.

11. The film layer structure as claimed in claim 8, wherein the target area has a thickness of zero.

12. The film layer structure as claimed in claim 8, wherein the film layer structure includes a back panel, the back panel includes three back panel sub-film layers of a back panel body, a protective film and a release film, and the back panel has at least one of the back panel sub-film layers provided with the target area.

13. The film layer structure as claimed in claim 8, wherein the film layer structure includes a back panel, the back panel includes at most two of the back panel sub-film layers in a back panel body, a protective film and a release film, and the back panel has at least one of the back panel sub-film layers provided with the target area.

14. The film layer structure as claimed in claim 13, wherein the back panel includes the back panel body and the release film, and the back panel body is provided with the target area.

15. The film layer structure as claimed in claim 8, wherein the film layer structure includes a polarizer, the polarizer includes four polarizing sub-film layers of a polarizing layer, a pressure sensitive adhesive, a release film and a protective film, and the polarizer has at least one of the polarizing sub-film layers provided with the target area.

16. The film layer structure as claimed in claim 8, wherein the film layer structure includes a polarizer, the polarizer includes at most three of polarizing sub-film layers in a polarizing layer, a pressure sensitive adhesive, a release film and a protective film, and the polarizer has at least one of the polarizing sub-film layers provided with the target area.

17. The film layer structure as claimed in claim 16, characterized in that the polarizer includes the polarizing layer, the pressure sensitive adhesive and the release film, and the polarizing layer and the release film are provided with the target area.

18. The film layer structure as claimed in claim 8, wherein the film layer structure includes a thin film transistor, the thin film transistor includes a metal layer, and the metal layer is provided with the target area.

19. The film layer structure as claimed in claim 8, wherein the target area is circular in shape.

20. The film layer structure as claimed in claim 8, wherein a width of the cutting area is greater than 30 μm.
